(19) United States
(12) Patent Application Publication
(10) Pub. No.: US 2007/0223233 A1
(43) Pub. Date: Sep. 27, 2007

(54) Lamp holder frame

(76) Inventor: Chin-Sheng Teng, San Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/717,032

(22) Filed: Mar. 13, 2007

(30) Foreign Application Priority Data
Mar. 23, 2006 (CN) 200620013226.6

(51) Int. Cl. F21V 15/00

(52) U.S. Cl. 362/362

(57) ABSTRACT

A lamp holder frame includes a base frame, a lamp holding frame and a rotating tool. A hole for rotating is formed in a center of the base frame. The hole can be a polygon hole, a circular hole with fixing grooves, a polygon hole with fixing grooves, a chisel hole or a cross hole. A fixing patch is cut out of a surface of the lamp holding frame and extends downwards from the surface. The base frame has a fixing groove corresponding to the fixing patch, to receive the fixing patch. The engagement of the rotating tool and the hole drives the lamp holding frame and the base frame to turn. The present invention can improve production efficiency and reduce the rejection rate. Compared with a conventional gluing method, the present invention achieves a prescribed torque standard in the industry, avoids inconvenience caused by using glue and reduces costs.

### BACKGROUND OF THE INVENTION

1. Field of the Invention

The present invention relates to a piece of lighting equipment, and more especially to a lamp holder frame for fixing a lamp holder.

2. Description of the Prior Art

In the field of illumination, there are many kinds of specifications for lamps and lanterns. Lamp holders are fixed via screw and buckle connections. A conventional lamp holder frame using a buckle connection is shown in FIG. 1. The lamp holder frame simply consists of a base frame 1a and a lamp holding frame 2a. To assembly, the lamp holder frame is twisted on to a connecting pipe (not shown) either manually or by a tool, the base frame 1a is connected with one end of the connecting pipe via screw threads, and then a lamp holder (not shown) is fastened in to the lamp holding frame 2a.

However, the lamp holder frame is made of metal thin plates or hard plastic sheets, so the lamp holder frame can not be attached firmly by hand. If twisted by a tool, the lamp holder frame is easily deformed and even damaged when the tool acts on the surface of the lamp holder frame. Furthermore, to meet a prescribed torque demand in the industry, after the conventional lamp holder frame is twisted on to the connecting pipe, glue has to be applied to the screw threads on the connecting pipe to attach the frame. Even then, it is difficult to achieve obvious effects and ungluing often occurs. Moreover, the use of glue is inconvenient and raises costs.

Hence, the inventors of the present invention believe that the shortcomings described above are able to be improved upon and suggest the present invention which is of a reasonable design and is an effective improvement based on deep research and thought.

### SUMMARY OF THE INVENTION

An object of the present invention is to provide a lamp holder frame which can be firmly fixed on a connecting pipe and is not damaged when twisted. The lamp holder frame is convenient and cheap.

To achieve the above-mentioned object, a lamp holder frame in accordance with the present invention is disclosed. A lamp holder frame includes a base frame having a hole for rotating and a lamp holding frame connected with the base frame.

A fixing patch is cut out of a surface of the lamp holding frame and extends downwards from the surface. The base frame has a fixing groove corresponding to the fixing patch to receive the fixing patch.

The hole is formed in a center of the base frame.

The hole can be, a polygon hole, a circular hole with fixing grooves, a polygon hole with fixing grooves, a chisel hole or a cross hole.

The lamp holder frame further includes a rotating tool which engages with the hole to rotatablely fix the base frame and the lamp holding frame.

The efficacy of the present invention is as follows: users can make the rotating tool engage with the hole of the lamp holder frame. Through revolving the rotating tool to drive the lamp holder frame to turn, the users can easily connect the lamp holder frame with a connecting pipe, which avoids the situation of the prior art in which the conventional lamp holder frames could not be fixed firmly by hand. Furthermore, damaging the lamp holder frame is also avoided, thereby improving production efficiency and reducing the rejection rate. Furthermore, because the fixing patch of the lamp holder frame inclines clockwise, when revolved clockwise, the connecting pipe can be clearly revolved into the hole on the base frame, and when revolved counterclockwise, the connecting pipe cannot be revolved out via the fixing patch locking screw teeth of the screw thread of the connecting pipe. Thereby the present invention achieves a prescribed torque standard in the industry and reduced costs.

To further understand features and technical contents of the present invention, please refer to the following detailed description and drawings related the present invention. However, the drawings are only to be used as references and explanations, and are not intended to limit the present invention.

### BRIEF DESCRIPTION OF THE DRAWINGS

FIG. 1 is an assembled perspective view of a conventional lamp holder frame;

FIG. 2 is an assembled perspective view of a lamp holder frame in accordance with the present invention;

FIG. 3 is an assembled sketched view of the lamp holder frame in accordance with the present invention;

FIG. 4 is a sketched view of a lamp holding frame of the lamp holder frame in accordance with the present invention;

FIG. 5 is a cutaway view of the portion of the lamp holder frame in accordance with the present invention, which connects with a connecting pipe; and

FIG. 6 is a sketched view of the lamp holder frame in accordance with the present invention, in an installed state.

### DETAILED DESCRIPTION OF THE INVENTION

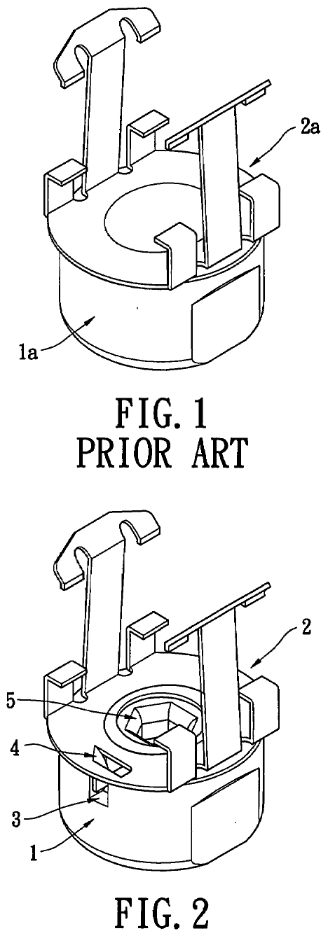

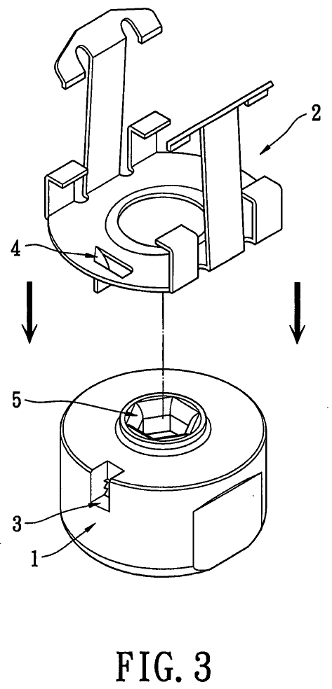

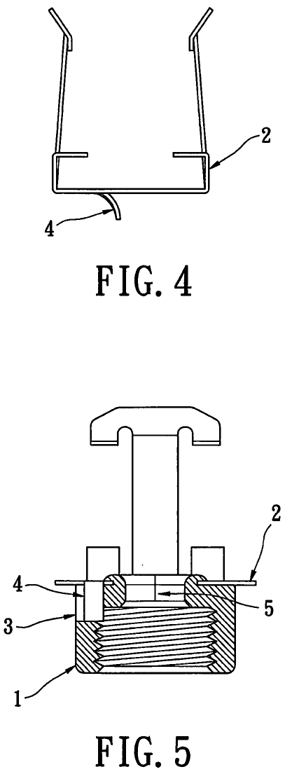

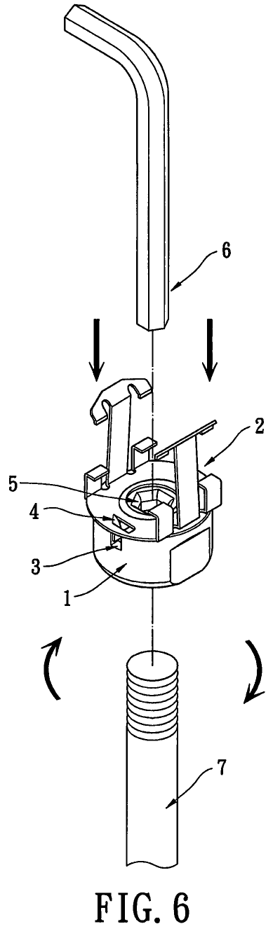

Please refer to FIGS. 2-4, a lamp holder frame in accordance with a preferred embodiment of the present invention is shown. The lamp holder frame includes a base frame 1, a lamp holding frame 2, and a rotating tool 6 (Please refer to FIG. 6). The lamp holding frame 2 is connected to the base frame 1 and can buckle a lamp holder (not shown) thereon. A fixing patch 4 is cut out of a surface of the lamp holding frame 2 and extends downwards from the surface. The base frame 1 has a fixing groove 3 corresponding to the fixing patch 4, to receive the fixing patch 4. A hole 5 for rotating is formed in a center of the base frame 1. The hole 5 can be a polygon hole, a circular hole with fixing grooves, a polygon hole with fixing grooves, a chisel hole or a cross hole, etc. The rotating tool 6 is for engaging with the hole 5 to rotatablely fix the base frame 1 and the lamp holding frame 2. In the embodiment, the hole 5 is a hexagon hole. The hole 5 can also be disposed on other positions (not shown) on the base frame 1, as long as the engagement of the hole 5 and the rotating tool 6 can drive the base frame 1 and the lamp holding frame 2 to turn.

Please refer to FIG. 5 and FIG. 6. To connect the hole 5 on the base frame 1 with a connecting pipe 7, it is necessary to choose a matching rotating tool 6. The rotating tool 6 can be a special tool or a freely chosen tool which can extend into the hole 5 on the base frame 1 and be locked in the hole 5 to ensure that the lamp holder frame can be rotatablely fixed on the connecting pipe 7. Therefore, the operation is convenient and avoids damaging the lamp holder frame.

Additionally, because the fixing patch 4 extends downwards from the surface of the lamp holding frame 2 and inclines clockwise after the fixing patch 4 is cut out, the connecting pipe 7 can be clearly revolved into the hole 5 on the base frame 1 clockwise. After the connecting pipe 7 is fixed, the connecting pipe 7 is revolved counterclockwise, the fixing patch 4 locks the screw teeth of the screw thread of the connecting pipe 7 so that the connecting pipe 7 cannot be revolved out, thereby achieving a needed torque standard and lowering costs.

Accordingly, the advantages of the lamp holder frame according to the present invention can be summed up as follows:
1. Users can easily connect the lamp holder frame with the connecting pipe 7 via engaging the rotating tool 6 and the hole 5 of the lamp holder frame. This approach avoids the situation in which conventional lamp holder frames cannot be fixed firmly by hand and avoids damaging the lamp holder frame, thereby improving production efficiency and reducing the rejection rate.
2. The engagement of the fixing patch 4 received in the fixing groove 3 and the connecting pipe 7 not only achieves a prescribed torque standard in the industry, but also reduces costs.

What is disclosed above is only the preferred embodiment of the present invention and it is therefore not intended that the present invention be limited to the particular embodiments disclosed. It will be understood by those skilled in the art that various equivalent changes may be made depending on the specification and the drawings of present invention without departing from the scope of the present invention.

What is claimed is:

1. A lamp holder frame, comprising:
a base frame, having a hole; and
a lamp holding frame, connecting with the base frame.

2. The lamp holder frame as claimed in claim 1, wherein a fixing patch is cut out of a surface of the lamp holding frame and extends downwards from the surface, and the base frame has a fixing groove corresponding to the fixing patch, to receive the fixing patch.

3. The lamp holder frame as claimed in claim 1, wherein the hole is formed in a center of the base frame.

4. The lamp holder frame as claimed in claim 1, wherein the hole is a polygon hole, a circular hole with fixing grooves, a polygon hole with fixing grooves, a chisel hole or a cross hole.

5. The lamp holder frame as claimed in claim 1, further comprising a rotating tool which engages with the hole to rotatablely fix the base frame and the lamp holding frame.
